(19) United States
(12) Patent Application Publication
(10) Pub. No.: US 2015/0189943 A1
(43) Pub. Date: Jul. 9, 2015

(54) ASSEMBLY COMPRISING A SHOE AND A PLATE FOR RETAINING THE SHOE ON AN AUTOMATIC BICYCLE PEDAL, RETAINING PLATE FOR SUCH AN ASSEMBLY, AND SHOE FOR THE LATTER

(71) Applicant: LOOK CYCLE INTERNATIONAL, NEVERS (FR)

(72) Inventor: Thierry FOURNIER, Saint-Paul (FR)

(21) Appl. No.: 14/590,063

(22) Filed: Jan. 6, 2015

(30) Foreign Application Priority Data
Jan. 9, 2014 (FR) 1450156

(51) Int. Cl. A43B 5/14; B62M 3/08; A43B 13/14

(52) U.S. Cl. CPC A43B 5/14; A43B 13/14; B62M 3/086

(57) ABSTRACT

An assembly includes a shoe and a plate retaining the shoe on an automatic bicycle pedal. The plate fixed under the shoe sole includes front and rear connecting elements cooperating with attachment elements on the pedal. The plate has a front part bearing the front connecting elements and a rear part bearing the rear connecting elements. The front and rear parts, fixed independently of each other under the sole, are mounted to be separated from each other by a flexing area extending between a front fixing location of the front part and a rear fixing location of the rear part. There is a bearing surface in the flexing area to substantially fill the space between the front and rear fixing locations to enable: the front and rear parts to effect a pivoting movement relative to each other when flexing the sole, and the bearing surface to bear on the pedal.

### BACKGROUND OF THE INVENTION

1. Field of the Invention

The present invention concerns an assembly comprising a shoe and a plate for retaining the shoe on an automatic bicycle pedal.

The retaining plate of the invention is a plate that can be detachably fixed under the sole of the shoe by fixing means generally comprising fixing screws passing through holes in the retaining plate to be screwed into threaded holes drilled in a metal plate anchored in the sole of the shoe.

This detachable retaining plate includes front connecting means and rear connecting means adapted to cooperate with front and rear attachment means, respectively, on the pedal. As a general rule, the front attachment means of the pedal are fixed and the rear attachment means are pivotably mounted. The rear attachment means are prestressed toward an attachment position by spring means and the shoe can be released from the automatic pedal by outward or inward rotation of the heel of the foot of the cyclist. How the automatic bicycle pedal works is well known and will not be described in more detail.

2. Description of the Related Art

Automatic pedals are of two types, namely so-called “road” automatic pedals and automatic pedals for all terrain bicycles (“ATB”).

At present both the shoes and the retaining plates used for road automatic pedals are different from those used for ATB automatic pedals. For road automatic pedals, the retaining plates are generally made of hard plastic material and are relatively large so as to extend over practically all the width of the sole. These retaining plates therefore have a large surface bearing against the automatic pedal. The soles of the shoes used with these large retaining plates for road pedals are generally flat and rigid. It is obvious that under these conditions walking in this kind of shoe—with “road” retaining plates—is particularly inconvenient and difficult. For this reason, assemblies of this kind are used practically exclusively for sports cycling and not for simple transport, for example for the journey to work or for carrying out errands.

The consequence of this is that the cyclist using a bicycle equipped with road automatic pedals simply for transport is more or less obliged to have a dedicated pair of shoes and then to change their shoes after reaching their destination. This is of course an undoubted inconvenience.

For ATB automatic pedals, the retaining plates are generally made of metal and are relatively small in order to be placed centrally on the sole and surrounded by crampons forming faces of the shoe bearing against the ground. The height of the crampons is adapted to suit that of the retaining plates and so the latter does not project downward beyond the crampons and is therefore protected by them. In other words, the retaining plate may be considered as embedded between the crampons.

These shoes and these retaining plates for ATB automatic pedals are more suitable for walking than “road” shoes and retaining plates. Thus “ATB” retaining plates are protected from wear of their large surface when “ATB” shoes are used for walking.

The major disadvantage of shoes dedicated to road automatic pedals is that their sole is completely lacking in flexibility. To be more precise, the sole is not able to flex at the front of the foot, which means that the amplitude and tone of the natural rolling motion of the foot are absent when walking.

It is therefore impossible to walk properly in these “road” shoes, in contrast to walking in conventional shoes known as city or sports shoes in which the contact with the ground is long and flexible and the rolling motion of the foot is effected from the heel to the tip of the foot with the foot flexing in the front part of its arch.

It might be thought that these problems would be solved if an “ATB”, and therefore small, plate were to be fixed to the flexible sole of a conventional sports shoe. However, it would be equally necessary in this case to start by integrating the metal plate for fixing the retaining plate anyway. It will then be found that when walking with such a shoe, the rolling motion of the foot is effected precisely at the location of the plate and the retaining plate, which would then greatly impede the correct rolling motion of the foot by neutralising the flexibility of the shoe precisely in this flexing area.

Another disadvantage of this solution is that, because the rest of the shoe is flexible and slightly compressible, when pedalling there is produced a pressure point over a small area, in contrast to the soles of cycling shoes for sports use, whether on road or competition ATB bicycles, which are extremely rigid to distribute the force correctly over the whole of the sole of the foot. This concentrated pressure point would then be experienced by the cyclist as a great nuisance because it would very quickly cause pain under the soles of the foot.

### SUMMARY OF THE INVENTION

An object of the invention is to remedy the drawbacks of known assemblies of this kind comprising a shoe and a plate for retaining the shoe on an automatic bicycle pedal, by proposing an assembly of this kind that is particularly suitable for walking by offering good rolling motion of the foot when walking and in which the force is distributed over a large area in which the feet bear on the pedals when pedalling.

The assembly in accordance with the invention can be used on a road cycling shoe with no crampons, on an ATB shoe with crampons protecting the retaining plate, or on a conventional city or sports shoe.

The invention consists in an assembly consisting of a shoe and a plate for retaining the shoe on an automatic bicycle pedal, said retaining plate being detachably fixable under the sole of the shoe and including front connecting means and rear connecting means adapted to cooperate with front attachment means and rear attachment means, respectively, on said pedal, said retaining plate being formed by a front part bearing said front connecting means and a rear part bearing said rear connecting means, said front and rear parts being adapted to be fixed independently of each other under the sole of the shoe, characterized in that in a mounted position said front and rear parts are separated from each other by a flexing area extending between a front fixing location of said front part and a rear fixing location of said rear part, and in that there is a bearing surface in said flexing area of the sole so as substantially to fill the space between said front and rear fixing locations of said front and rear parts so as on the one hand to enable said front and rear parts to effect a movement of pivoting relative to each other as a function of flexing of said sole in said flexing area when said assembly is used when walking and on the other hand to enable said bearing surface to come to bear on an automatic pedal.

In accordance with other features of the invention:

the bearing surface is a transverse bearing rib adapted to come to bear on the pedal in said flexing area of the sole so as substantially to fill the space between said front and rear fixing locations of said front and rear parts;

said transverse bearing rib is in one piece with the sole;

said transverse bearing rib is an attached element fixed in said flexing area of the sole;

said front connecting means of said front part lie in a so-called front recess of the sole sized to receive additionally front attachment means of said pedal;

said rear connecting means of said rear part lie in a so-called rear recess of the sole sized to receive additionally rear attachment means of said pedal, said rear recess opening onto at least one of the lateral sides of the sole;

in another variant, said bearing surface is formed by flexible connecting means connecting said front and rear parts to each other;

said flexible connecting means are made of a material with inherent flexibility different from the material of said front and rear parts;

said flexible connecting means take the form of a thin flexible blade in one piece with said front and rear parts;

said flexible connecting means in the form of a thin flexible blade include transverse ribs on at least one face thereof;

said flexible connecting means include a rear protuberance of said front part slidably mounted on a front protuberance of said rear part so as to enable flexing in said flexing area of the sole; and

said rear protuberance of said front part is guided in a recess in the facing surface of said front protuberance of said rear part;

said sole is a rigid sole comprising at least three parts connected to one another by transverse articulations one of which is immediately in front of said rear fixing location of said rear part and another of which is immediately behind said front fixing location of said front part;

said articulations are formed by axles;

said articulations are formed by a flexible glue or an elastomer.

The invention also concerns a retaining plate including front connecting means and rear connecting means adapted to cooperate with front and rear attachment means on an automatic bicycle pedal, said retaining plate being formed by a front part bearing said front connecting means and a rear part bearing said rear connecting means, said front and rear parts being adapted to be fixed independently of each other under a sole of a shoe, characterized in that in a position mounted under the sole, said front and rear parts are separated from each other by a flexing area extending between a front fixing location of said front part and a rear fixing location of said rear part, there being a bearing surface in said flexing area of the sole so as substantially to fill the space between said front and rear fixing locations of said front and rear parts on the one hand to enable said front and rear parts to effect a pivoting movement relative to each other as a function of flexing of said sole in said flexing area when the shoe equipped with the retaining plate is used when walking and on the other hand to enable said bearing surface to come to bear on an automatic pedal.

In accordance with other features of the retaining plate:

said front and rear parts are connected to each other by flexible connecting means forming said bearing surface;

said flexible connecting means are made of a material having inherent flexibility different from the material of said front and rear parts;

said flexible connecting means take the form of a thin blade in one piece with said front and rear parts;

said thin blade has transverse ribs on at least one of its faces; and

said flexible connecting means include a rear protuberance of said front part slidably mounted on a front protuberance of said rear part so as to enable flexing in said flexing area of the sole.

The invention also concerns shoe including under its sole a so-called front fixing location and a so-called rear fixing location to receive independently of each other a front part and a rear part, respectively, together serving as a plate for retaining the shoe on an automatic pedal, characterized in that it includes a flexing area extending the entire width of the sole between said front and rear fixing locations and adapted, in a mounted position, to separate the front part and the rear part, and in that there is a bearing surface in said flexing area of the sole so as substantially to fill the space between said front and rear fixing locations of said front and rear parts, so as on the one hand to enable said front and rear parts to effect a movement of pivoting relative to each other as a function of flexing of said sole in said flexing area when the shoe equipped with the retaining plate is used when walking and on the other hand to enable said bearing surface to come to bear on an automatic pedal.

In accordance with other features of the shoe:

the bearing surface is a transverse bearing rib under the sole in said flexing area so as substantially to fill the space between said firs front and rear fixing locations of said front and rear parts; and

said sole is a rigid sole comprising three parts connected to one another by transverse articulations one of which is immediately in front of said rear fixing location and the other of which is immediately behind said front fixing location.

### BRIEF DESCRIPTION OF THE DRAWINGS

Other features and advantages of the invention will emerge from the following description of nonlimiting embodiments of the invention given with reference to the appended figures, in which:

FIG. 1 is a perspective view from below of a shoe in accordance with the invention of the sports shoe type;

FIG. 2 is a perspective view from below of a sole of a shoe in accordance with the invention;

FIG. 3 is a perspective view from below of a retaining plate in accordance with the invention comprising a front part and a rear part;

FIG. 4 is a perspective view from above of the shoe sole from FIG. 2 showing two plates for fixing the two parts of the retaining plate from FIG. 3;

FIG. 5 is a perspective view from below of the shoe sole from FIG. 2 onto which the two parts of the retaining plate from FIG. 3 have been fixed;

FIG. 6 is a perspective view from below of a city shoe sole in accordance with the invention with no crampons;

FIG. 7 is a perspective view from below of a “road” type shoe sole, with no crampons, in accordance with the invention, and attached to an automatic pedal;

FIG. 8 is a perspective view from below of the sole and the automatic pedal from FIG. 7 showing a phase of release of the shoe sole by outward rotation;

FIG. 9 is a perspective view from below of a sole for a road shoe in accordance with the invention comprising three parts and with axles forming articulations between the parts;

FIG. 10 is a side view of a sole similar to that from FIG. 9 with another type of articulation between the three parts of the sole;

FIG. 11 is a partial side view to a larger scale of the sole from FIG. 10;

FIG. 12 is a side view of the sole from FIG. 10 showing the flexing of the sole for walking;

FIG. 13 is a bottom view of a sole similar to that shown in FIG. 2 provided with a retaining plate in which the two front and rear parts of the retaining plate are connected by flexible connecting means;

FIG. 14 is a perspective view from below showing separately the retaining plate from FIG. 13;

FIG. 15 is a perspective view from below showing a variant of the retaining plate from FIG. 14;

FIG. 16 is a side view showing another embodiment of the retaining plate in which the two parts forming the plate can slide one on the other;

FIG. 17 is a perspective view showing the retaining plate from FIG. 16 during pedalling; and

FIG. 18 is a perspective view showing the relative sliding of the front and rear parts of the retaining plate from FIG. 16 when walking.

### DETAINED DESCRIPTION OF THE PREFERRED EMBODIMENT

In the figures, identical or equivalent elements will bear the same reference signs.

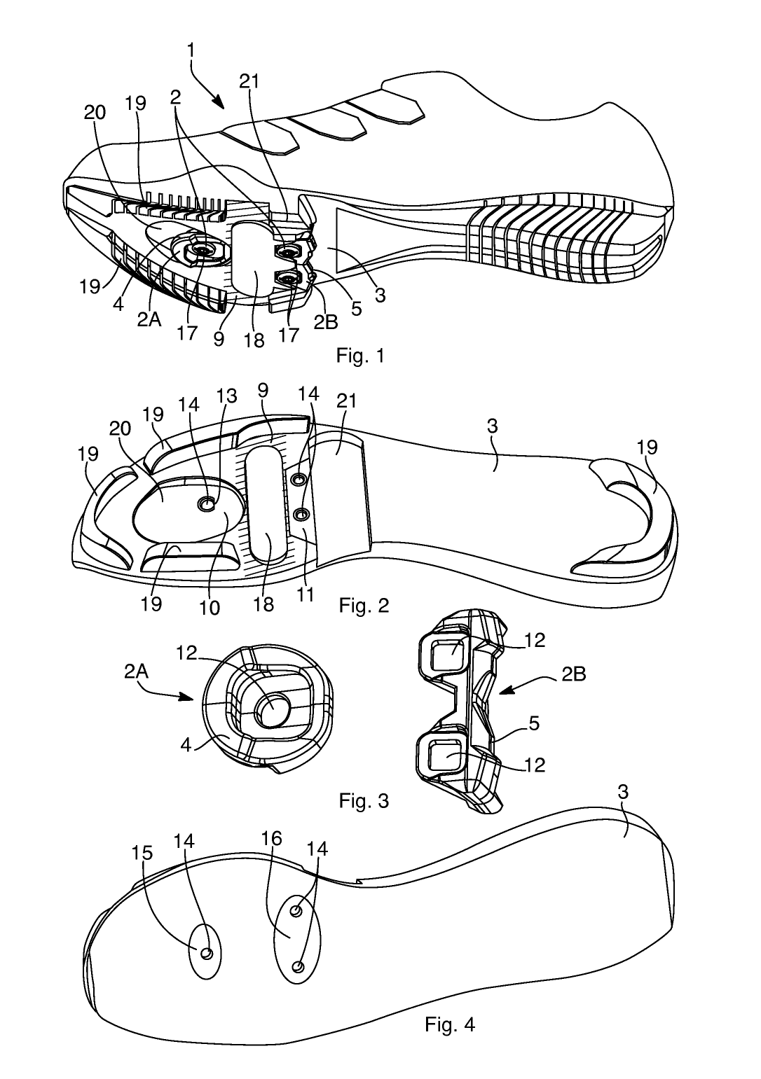

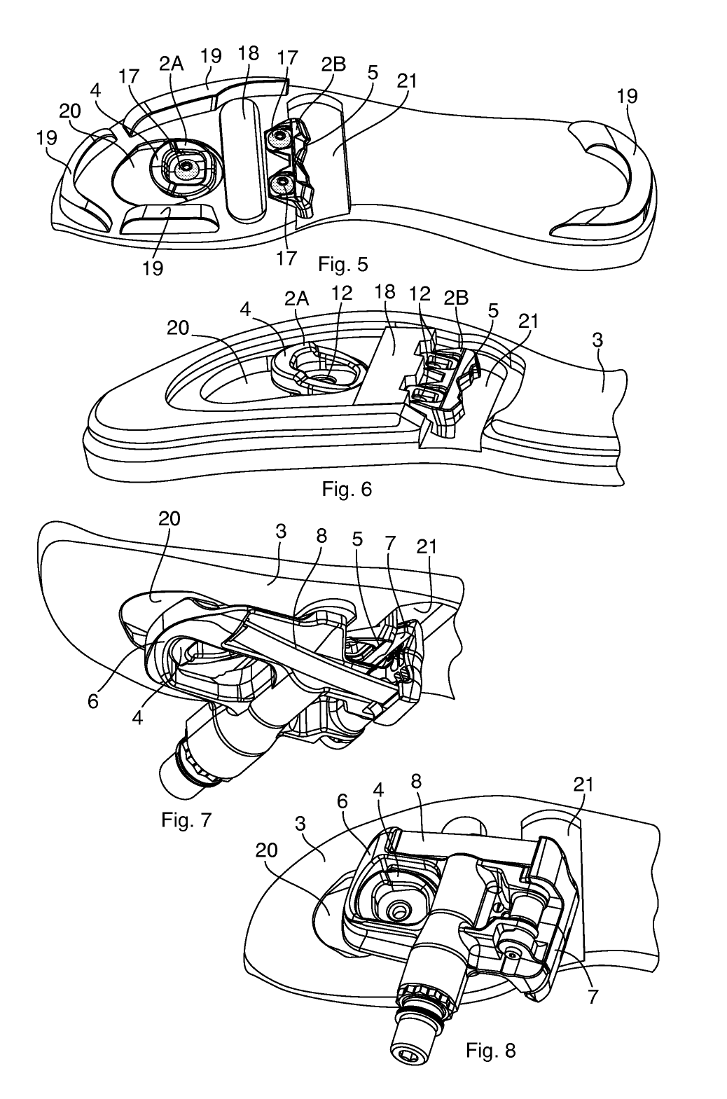

FIG. 1 shows an assembly in accordance with the invention comprising a shoe 1 and a retaining plate 2 detachably fixed under the sole 3 of the shoe. The retaining plate 2 includes front connecting means 4 and rear connecting means 5 adapted to cooperate with front attachment means 6 and rear attachment means 7, respectively, of an automatic bicycle pedal 8 (see FIG. 7). The retaining plate 2 is preferably made of a hard plastic material or a light metal.

In accordance with the invention, the retaining plate 2 is formed by a first part 2A, referred to as the front part, bearing the front connecting means 4 and a second part 2B, referred to as the rear part, bearing the rear connecting means 5. These first and second parts 2A, 2B can be fixed independently of each other under the sole 3 of the shoe 1.

In this embodiment, the sole 3 is rendered flexible over all its width in a flexing area 9 (shown shaded in FIGS. 1 and 2). This flexing area 9 is defined between a front fixing location 10 (see FIG. 2) of the front part 2A and a rear fixing location 11 of the rear part 2B of the retaining plate 2.

Thanks to the flexibility of the flexing area 9, the front and rear parts 2A, 2B can effect a pivoting movement relative to each other as a function of flexing of the sole 3 in this flexing area 9 when the assembly comprising the shoe and the retaining plate is used when walking. In other words, the sole 3 is adapted to follow the natural rolling motion of the foot that is effected from the heel to the tip of the foot by flexing the foot at the level of the front part of its arch.

In the example shown in FIG. 1, the shoe is a sports shoe with a sole 3 the flexibility of which in the flexing area 9 is obtained by virtue of the fact that the sole is made of a material having inherent flexibility, unlike conventional cycling shoes.

The sole shown in FIG. 2 is also a sole made of a flexible material enabling flexing of the flexing area 9. In both cases, the sole therefore allows flexing not only in the flexing area 9 but also over all its length.

FIG. 3 shows in more detail and separately the front part 2A and the rear part 2B forming the retaining plate 2. The front part 2A includes a single central fixing hole 12 and the rear part 2B includes two fixing holes 12 symmetrically placed on it and offset towards the opposite sides. The front part 2A is prevented from rotating by means of a flat 13 alongside a threaded fixing hole 14 in the sole 3 that cooperates with a corresponding rim (not shown) in the body of the front part 2A on the side facing towards the sole.

FIG. 4 shows the upper face of the sole 3 from FIG. 2. This side of the sole includes fixing plates 15, 16 of which a front plate 15 includes the threaded fixing hole 14 and a rear plate 16 includes two threaded fixing holes 14. All the fixing holes 14 open onto the other side of the sole (see FIG. 2) to cooperate with fixing screws 17 passing through the fixing holes 12 in the front and rear parts 2A, 2B.

In accordance with one feature of the invention, there is a transverse bearing rib 18 adapted to come to bear on the automatic pedal 8 in the flexing area 9 of the sole 3. This bearing rib 18 substantially fills the space between the front and rear fixing locations 10, 11 of the front and rear parts 2A, 2B of the retaining plate 2.

Thanks to the presence of this bearing rib 18, the force transmitted by the foot is distributed over a large area under the latter, which avoids having too concentrated a pressure point in the flexing area 9.

The soles shown in FIGS. 1 and 2 further include crampons 19 which in these examples extend along the edge of the sole. The crampons 19 are intended to serve as surfaces bearing against the ground when the shoe is used for walking.

In one embodiment the bearing rib 18 is in one piece with the sole 3 and in another embodiment it is an attached element fixed, for example glued, in the flexing area 9 of the sole 3.

The front connecting means 4 of the front part 2A lie in a so-called front recess 20 in the sole 3. This recess is sized to receive additionally the front attachment means 6 of the pedal 8 (see FIG. 7). It also defines the front fixing location 10.

In the same way, at least the rear part of the rear connecting means 5 of the rear part 2B lies in a rear recess 21 in the sole 3 to receive additionally the rear attachment means 7 of the pedal 8 (see FIGS. 7 and 8). This rear recess 21 opens onto at least one of the lateral sides of the sole 3 in order to enable rotation of the shoe to release the retaining plate 2 engaged between the front and rear attachment means 6, 7 of the pedal 8.

FIG. 8 shows the phase of releasing the shoe sole 3 from the front and rear attachment means 6, 7 of the automatic pedal 8 by outward rotation. It is seen that an end portion of the rear attachment means 7 then projects from the rear recess 21 opening onto this side.

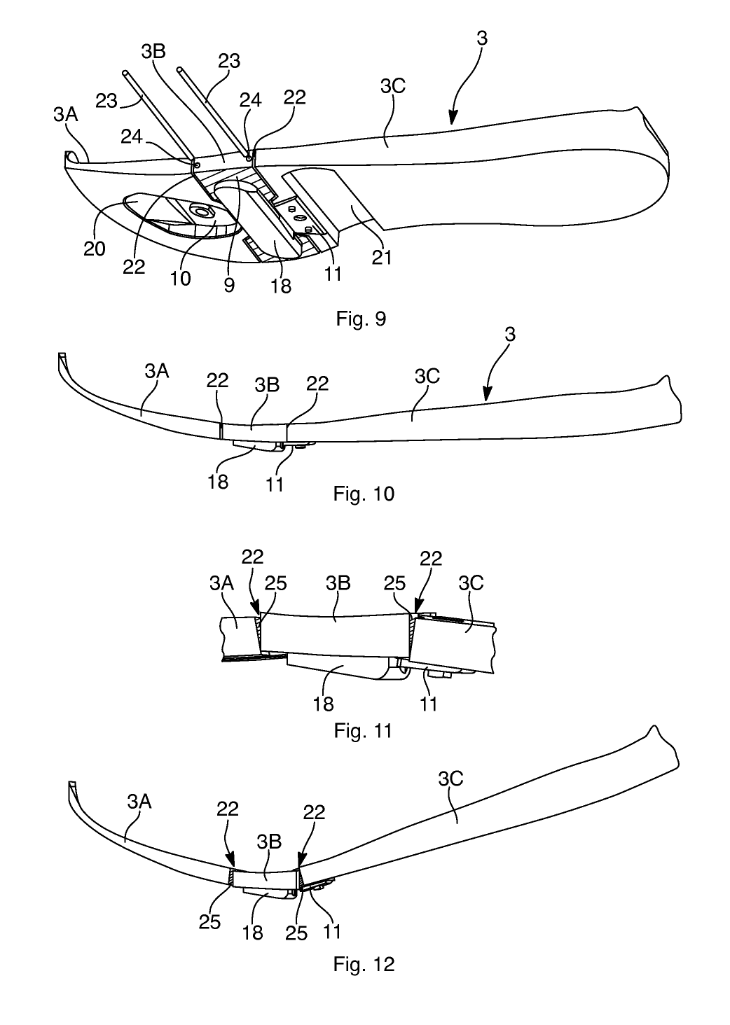

FIG. 9 shows a sole 3 that is made of a rigid material such as that used at present in cycling shoes. In the example shown this rigid sole comprises three parts, namely a front part 3A, an intermediate part 3B and a rear part 3C. The intermediate part 3B defines a flexing area 9 by virtue of being connected to the front sole part 3A and the rear sole part 3C by transverse articulations 22 one of which is immediately in front of the rear fixing location 11 and another of which is immediately behind the front fixing location 10 under the sole 3. This renders the rigid sole 3 flexible in the flexing area 9.

In the example shown, the intermediate sole portion 3B also bears a transverse bearing rib 18 analogous to that described with reference to FIGS. 1 and 2.

In the embodiment shown in FIG. 9, the transverse articulations 22 include axles 23 received in holes 24 in the intermediate sole part 3B. The holes 24 are in the upper portion of the intermediate part 3B so that the sole 3 is flexible only in the direction of rolling motion of the foot of the cyclist, while in the other direction the end surfaces between the front part 3A and the intermediate part 3B as well as between the latter and the rear part 3C come to abut against one another. The sole 3 is therefore rendered flexible for walking while it remains rigid when it is attached to the automatic pedal.

In a variant of the sole shown in FIGS. 10 to 12, the sole portions 3A, 3B and 3C are connected to one another by transverse articulations 22 formed by a flexible glue 25 that provides the same functions as the axles 23 used in the articulations described with reference to FIG. 9.

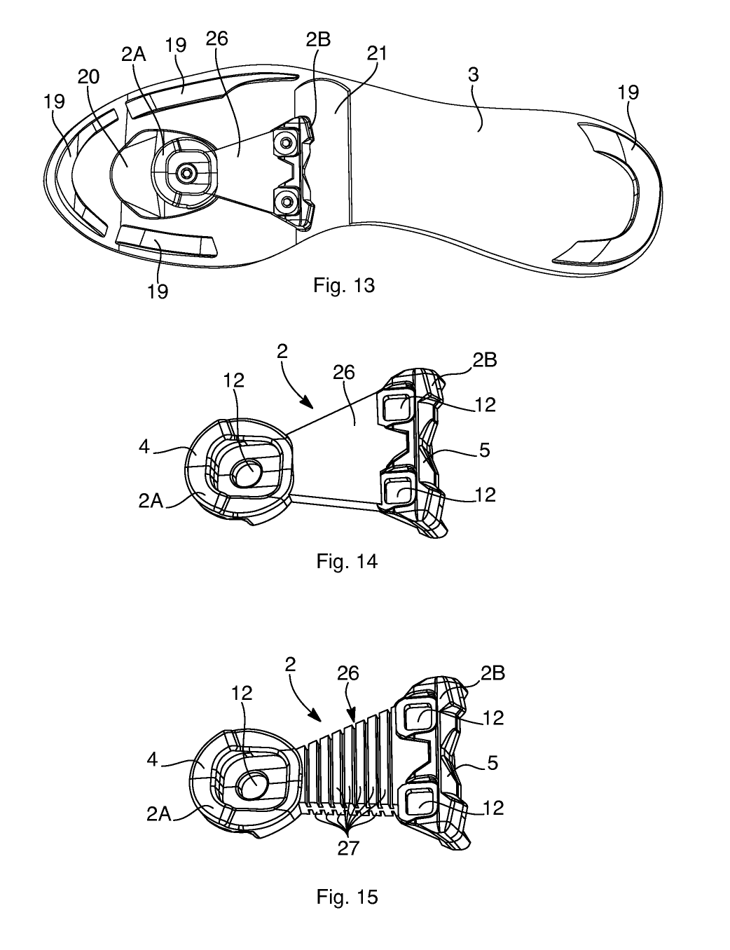

In another embodiment of the assembly in accordance with the invention, the front and rear parts 2A, 2B of the retaining plate 2 are connected to each other by flexible connecting means 26 of truncated triangular shape, as shown in FIGS. 13 to 15. Here, the lower face of the flexible connecting means 26 forms the bearing surface that will come to bear on the automatic pedal.

The connecting means 26 shown in FIG. 14 are preferably made of a material having inherent flexibility, for example elastomer, different from the material of the front and rear parts 2A, 2B of the retaining plate 2, which are made of hard material.

Alternatively, the connecting means 26 take the form of a thin blade in one piece with the front and rear parts 2A, 2B of the retaining plate 2.

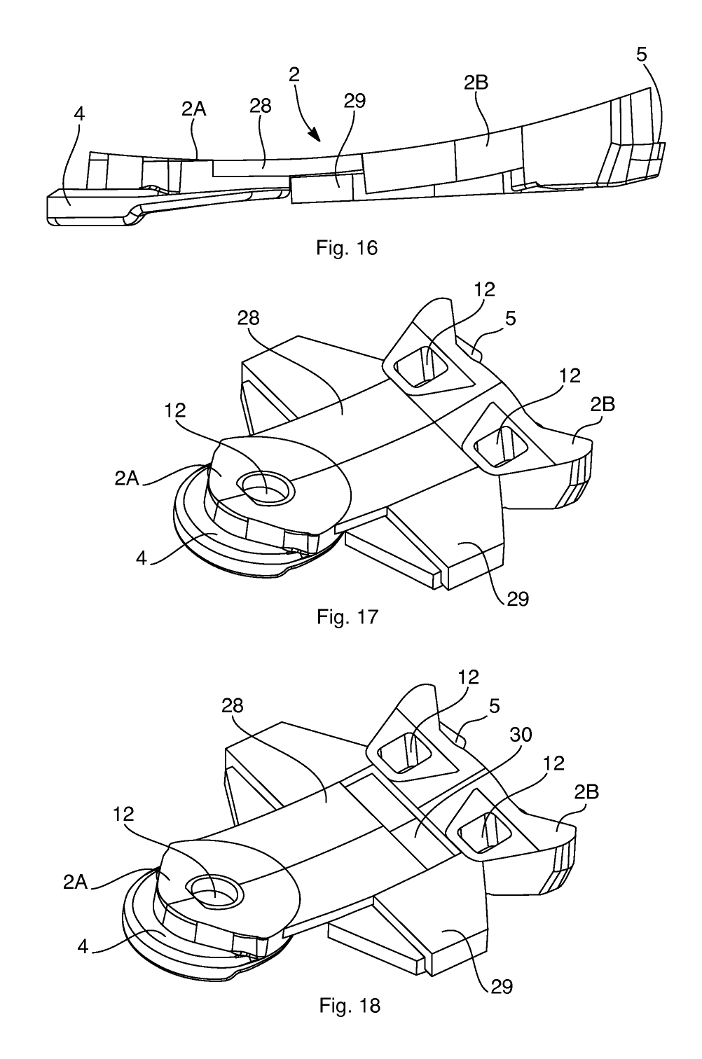

In a further variant shown in FIG. 15, this thin blade includes transverse stiffener ribs 27 disposed at a distance from one another so that flexing of the connecting means 26 is still possible.

The transverse ribs 27 can of course be on a single face of the connecting means 26, preferably on the lower face of the element.

Finally, FIGS. 16 to 18 show a variant of the connecting means between the front part 2A and the rear part 2B of the retaining plate 2. In this variant, the connecting means include a rear protuberance 28 of the front part 2A slidably mounted on a front protuberance 29 of the rear part 2B so as to enable flexing in the flexing area 9 of the sole 3.

The rear protuberance 28 of the front part 2A is advantageously guided in a recess 30 of complementary shape in the facing surface of the front protuberance 29 of the rear part 2B. The surfaces in contact may be shaped so that sliding may be effected linearly or along a circular arc.

The retaining plates shown in FIGS. 14 to 18 may be used interchangeably on shoes with a rigid sole comprising at least three parts, similar to that shown in FIGS. 9 to 12, or on flexible sole shoes, at least partly in the flexing area 9, similar to those shown in FIG. 2, 5 or 6. In this case, it is not necessary to equip the soles with a transverse rib 18 since the surface bearing on the automatic pedal will be formed directly by the lower face of the flexible connecting means 26.

Of course, the invention is not limited to the examples shown and described, and a large number of variants and combinations may be envisaged without departing from the scope of the invention. It is particularly well adapted to be applied to standard city shoes and sports shoes.

1. Assembly consisting of a shoe (1) and a plate (2) for retaining the shoe on an automatic bicycle pedal (8), said retaining plate being detachably fixable under the sole (3) of the shoe (1) and including front connecting means (4) and rear connecting means (5) adapted to cooperate with front attachment means (6) and rear attachment means (7), respectively, on said pedal, said retaining plate (2) being formed by a front part (2A) bearing said front connecting means (4) and a rear part (2B) bearing said rear connecting means (5), said front and rear parts (2A, 2B) being adapted to be fixed independently of each other under the sole (3) of the shoe (1), wherein in a mounted position said front and rear parts are separated from each other by a flexing area (9) extending between a front fixing location (10) of said front part (2A) and a rear fixing location (11) of said rear part (2B), and there is a bearing surface (18; 26) in said flexing area (9) of the sole (3) so as substantially to fill the space between said front and rear fixing locations (10, 11) of said front and rear parts (2A, 2B) so as to enable said front and rear parts (2A, 2B) to effect a movement of pivoting relative to each other as a function of flexing of said sole (3) in said flexing area (9) when said assembly is used when walking and to enable said bearing surface (18; 26) to come to bear on an automatic pedal.

2. Assembly according to claim 1, wherein said bearing surface (18) is a transverse bearing rib (18) in said flexing area (9) of the sole (3).

3. Assembly according to claim 2, characterized in that said transverse bearing rib (18) is in one piece with the sole (3).

4. Assembly according to claim 2, wherein said transverse bearing rib (18) is an attached element fixed in said flexing area (9) of the sole (3).

5. Assembly according to claim 1, wherein said bearing surface is formed by flexible connecting means (26) connecting said front and rear parts (2A, 2B) to each other.

6. Assembly according to claim 5, wherein said flexible connecting means (26) is made of a material with inherent flexibility different from the material of said front and rear parts (2A, 2B).

7. Assembly according to claim 5, wherein said flexible connecting means (26) take the form of a thin flexible blade in one piece with said front and rear parts (2A, 2B).

8. Assembly according to claim 7, wherein said flexible connecting means (26) in the form of a thin flexible blade include transverse ribs (27) on at least one face thereof.

9. Assembly according to claim 5, wherein said flexible connecting means (26) include a rear protuberance (28) of said front part (2A) slidably mounted on a front protuberance (29) of said rear part (2B) so as to enable flexing in said flexing area (9) of the sole (3).

10. Assembly according to claim 9, wherein said rear protuberance (28) of said front part (2A) is guided in a recess (30) in the facing surface of said front protuberance (29) of said rear part (2B).

11. Assembly according to claim 1, wherein said sole (3) is a rigid sole (3) comprising at least three parts (3A, 3B, 3C) connected to one another by transverse articulations (22) one of which is immediately in front of said rear fixing location (11) of said rear part (2B) and another of which is immediately behind said front fixing location (10) of said front part (2A), the portion (3B) situated between the transverse articulations forming said flexing area (9).

12. Assembly according to claim 11, wherein said articulations (22) are formed by axles (23).

13. Assembly according to claim 11, wherein said articulations (22) are formed by a flexible glue (25) or an elastomer.

14. Assembly according to claim 1, wherein said front connecting means (4) of said front part (2A) lie in a so-called front recess (20) of the sole (3) sized to receive additionally front attachment means (6) of said automatic pedal (8).

15. Assembly according to, wherein said rear connecting means (5) of said rear part (2B) lie in a so-called rear recess (21) of the sole (3) sized to receive additionally rear attachment means (7) of said automatic pedal (8), said rear recess (21) opening onto at least one of the lateral sides of the sole (3).

16. Retaining plate (2) including front connecting means (4) and rear connecting means (5) adapted to cooperate with front and rear attachment means (6, 7) on an automatic bicycle pedal (8), said retaining plate being formed by a front part (2A) bearing said front connecting means (4) and a rear part (2B) bearing said rear connecting means (5), said front and rear parts (2A, 2B) being adapted to be fixed independently of each other under a sole (3) of a shoe (1), wherein in a position mounted under the sole, said front and rear parts are separated from each other by a flexing area (9) extending between a front fixing location (10) of said front part (2A) and a rear fixing location (11) of said rear part (2B), there being a bearing surface (18; 26) in said flexing area (9) of the sole (3) so as substantially to fill the space between said front and rear fixing location (10, 11) of said front and rear parts (2A, 2B) to enable said front and rear parts (2A, 2B) to effect a pivoting movement relative to each other as a function of flexing of said sole (3) in said flexing area (9) when the shoe equipped with the retaining plate is used when walking and to enable said bearing surface (18; 26) to come to bear on an automatic pedal.

17. Retaining plate (2) according to claim 16, wherein said front and rear parts (2A, 2B) are connected to each other by flexible connecting means (26) forming said bearing surface.

18. Retaining plate (2) according to claim 17, wherein said flexible connecting means (26) are made of a material having inherent flexibility different from the material of said front and rear parts (2A, 2B).

19. Retaining plate (2) according to claim 17, wherein said flexible connecting means (26) take the form of a thin blade in one piece with said front and rear parts (2A, 2B).

20. Retaining plate (2) according to claim 19, wherein said thin blade has transverse ribs (27) on at least one of its faces.

21. Retaining plate (2) according to claim 17, wherein said flexible connecting means (26) include a rear protuberance (28) of said front part (2A) slidably mounted on a front protuberance (29) of said rear part (2B) so as to enable flexing in a flexing area (9) of a sole (3).

22. Retaining plate (2) according to claim 21, wherein said rear protuberance (28) of said front part (2A) is guided in a recess (30) in the facing surface of said front protuberance (29) of said rear part (2B).

23. Shoe (1) including under its sole (3) a front fixing location (10) and a rear fixing location (11) to receive independently of each other a front part (2A) and a rear part (2B), respectively, together serving as a plate (2) for retaining the shoe (1) on an automatic pedal (8), wherein the shoe further includes a flexing area (9) extending the entire width of the sole (3) between said front and rear fixing locations (10, 11) and adapted, in a mounted position, to separate the front part (2A) and the rear part (2B), and there is a bearing surface (18; 26) in said flexing area (9) of the sole (3) so as substantially to fill the space between said front and rear fixing locations (10, 11) of said front and rear parts (2A, 2B) so as to enable said front and rear parts (2A, 2B) to effect a movement of pivoting relative to each other as a function of flexing of said sole (3) in said flexing area (9) when the shoe equipped with the retaining plate is used when walking and to enable said bearing surface (18; 26) to come to bear on an automatic pedal.

24. Shoe (1) according to claim 23, wherein the bearing surface is a transverse bearing rib (18) under the sole (3) in said flexing area (9).

25. Shoe (1) according to claim 23, wherein said sole (3) is a rigid sole comprising three parts (3A, 3B, 3C) connected to one another by transverse articulations (22) one of which is immediately in front of said rear fixing location (11) and the other of which is immediately behind said front fixing location (10), the portion (3B) situated between the transverse articulations forming said flexing area (9).
